(19) United States
(12) Patent Application Publication
(10) Pub. No.: US 2019/0347712 A1
(43) Pub. Date: Nov. 14, 2019

(54) METHOD AND SYSTEM FOR PREPARING AN ORDER SOLELY WITHIN THE eCATALOG SECTION OR MODULE OF AN ONLINE SHOPPING CART MODEL STORE (i-Order)

(71) Applicant: Jon Nils FOGELBERG, Stillwater, MN (US)

(72) Inventor: Jon Nils FOGELBERG, Stillwater, MN (US)

(21) Appl. No.: 15/720,860

(22) Filed: Sep. 29, 2017

(51) Int. Cl. G06Q 30/06

(52) U.S. Cl. CPC G06Q 30/0641; G06Q 30/0633

(57) ABSTRACT

A method and system for creating a dynamic multi-functional “Add-to-Cart” button which streamlines the order processing through an internet online store. The purpose of this new “Add-to-Cart” button is to enable an Internet shopper the option of completing an entire order with the button in the Add-to-Cart module of an online shopping model. This new method and system of internet shopping allows the shopper to make more informed order decisions faster than navigating to different pages on a web site, reduces the chances that the shopper will abandon their shopping activity and reduces the chances of incorrect orders or ill informed orders resulting in fewer returns.

### CROSS-REFERENCE TO RELATED APPLICATIONS

This application claims the benefit of U.S. provisional application Ser. No. 62/401,365, filed Sep. 29, 2016.

### BACKGROUND OF THE INVENTION

Internet shopping is increasing in popularity in the United States. It is estimated that there are over 100,000 U.S.-based online retail stores as of 2015. The U.S. Census Bureau News published by the U. S. Department of Commerce in Washington, D.C. stated that the quarterly retail e-commerce sales in the 4^{th} Quarter 2015, adjusted for seasonal variation, but not for price changes, was $89.1 billion. The same report stated that the total e-commerce sales for 2015 were estimated to be $341.7 billion, an increase of 14.6 percent from 2014. A chart contained in the same report indicated that e-commerce sales have risen steadily since 2006 and, by projection, it looks as if retail e-commerce sales as a percent of Total Quarterly Retail Sales will approach 10% in the not too distant future.

The growth of internet shopping is its own testament regarding the fact that there are many advantages for the shopper to shop from home or office and have items delivered directly to home or office often within one or two days if the shopper subscribes to premium membership offerings. Unfortunately, the shopping cart model used by most online retail stores is extremely inefficient and burdensome and involves too many steps and too much website navigation for the average shopper who is easily frustrated when the shopping procedure becomes too cumbersome or subject to errors resulting in unintended purchases or incorrect quantities being shipped to the shopper with the resultant difficulties and delays of returning unwanted items to the online retail store.

In a recent study which compared the cart abandonment rate statistics of 33 different studies, the average abandonment rate was 68.63%. In other words, over ⅔^{rd}'s of all shoppers on the internet did not buy anything after reviewing the offerings of online stores and they simply abandoned or “clicked-off” before completing a purchase. Even worse, of the shoppers who did buy items through the internet, ABC News reported on Dec. 24, 2016 that “about a third of all internet transactions are returned by shoppers”.

After the traditional Add-to-Cart button is clicked, the user has no idea on what the next action will be. The follow on action of clicking the Add-to-Cart button, begins one of two processes, a hard cart or a soft cart. Using the hard cart method, the user is taken to the Shopping Cart for review after each item is added. The soft cart method, varies significantly across platforms, providing the user with some notification method that a specific action has happened. Both of these methods slow the e-commerce shopping experience, providing inconsistent results and in some cases move the shopper away from the very section where they are adding products to the cart. For example, if shopping at a brick-and-mortar grocery store, after adding an apple to the cart, the user might be taken out of the produce department and placed directly in the check-out line. Imagine if you would, if each time you added an item to your brick-and-mortar shopping cart if a store clerk had to ask you, would you like to continue shopping or would you like to check out? Further, what if a brick-and-mortar store forced you to place a black bag over your shopping cart preventing you from viewing the carts contents throughout the shopping experience. Only after removing the black bag could you visually inspect the carts contents. Brick-and-mortar shoppers would never put up with that, yet are forced to face this reality today during every e-commerce shopping experience.

Change is needed to refine the e-commerce shopping experience. The present invention aligns traditional brick-and-mortar shopping to e-commerce online shopping. Consider this, when adding an apple to the traditional brick-and-mortar shopping cart, the user places the apple in the cart and then immediately starts perusing similar items in that section. The present invention replicates this behavior by placing the selected item in the e-commerce shopping cart, providing instant, positive feedback that the action has happened, and leaves the shopper in the exact same section enabling, more shopping. The invention could significantly increase e-commerce revenue by drawing on the traditional brick-and-mortar shopping experiences. In that same regard, the present invention aligns the e-commerce shopping cart to that of the brick-and-mortar shopping cart. As items are added to the e-commerce shopping cart, the buyer can easily view cart contents just as they do in the brick-and-mortar shopping cart.

### SUMMARY OF THE INVENTION

An embodiment of the present invention provides a method and system for preparing an order to be placed on the internet. An internet online shopper reviews product offerings available through an inline internet store. When the shopper decides to purchase an item the shopper clicks on the new “Add-To-Cart” button which is adjacent to the product to be purchased. This activates the “In-My-Cart” button which remains activated until the shopper completes their shopping activity for that particular order. If additional items are selected to be ordered the “Add-to-Cart” buttons all remain activated until the shopper removes a particular item or checks out of the online store. The activated buttons are referred to as dynamic “Add-to-Cart” buttons.

As the internet shopper reviews product offerings in an online store, many questions about the product often arise. The dynamic “In-My-Cart” button is designed to answer these questions utilizing a series of tiered pop-up windows.

### BRIEF DESCRIPTION OF THE DRAWINGS

FIG. 1 illustrates a typical e-Commerce website shopping page. It is part of an electronic computer style shopping catalog which may contain innumerable pages and innumerable items for sale. The shopper browses through the catalog, finds an item which the shopper wishes to purchase and clicks on the “Add to Cart” button and this action adds the item to the Shopping Cart page which is not illustrated here.

FIG. 2 is a block diagram illustrating an embodiment of the present invention and demonstrates how a shopper initiates the Add to Cart button with a click of the mouse or stylus or finger and the first item to be ordered is shown in an “In-My-Cart” pop-up electronic window summary of the order which is also placed in the shoppers Shopping Cart which is not shown here. Also, once the first piece of information is requested . . . the quantity which can be adjusted up or down as required by the shopper entering a new number or a pull down menu.

FIG. 3 is a block diagram illustrating how the “In-My-Cart” window stays with the shopper as the shopper browses through the catalog and reflects new information as additional purchases are made. If many items are placed in the “In-My-Cart” window the shopper may view them by scrolling up or down in the window.

FIG. 4 is a block diagram illustrating the use of sub-pop-up windows only in the event the shopper elects to acquire more information about an item by clicking the “More Information Please” button.

FIG. 5 is similar to FIG. 4 with the addition of an optional “Panoramic View Of Store”.

### DETAILED DESCRIPTION OF THE PRESENT INVENTION

The present invention provides a method and system for preparing an order solely within the eCatalog section or module of an online shopping cart model store.

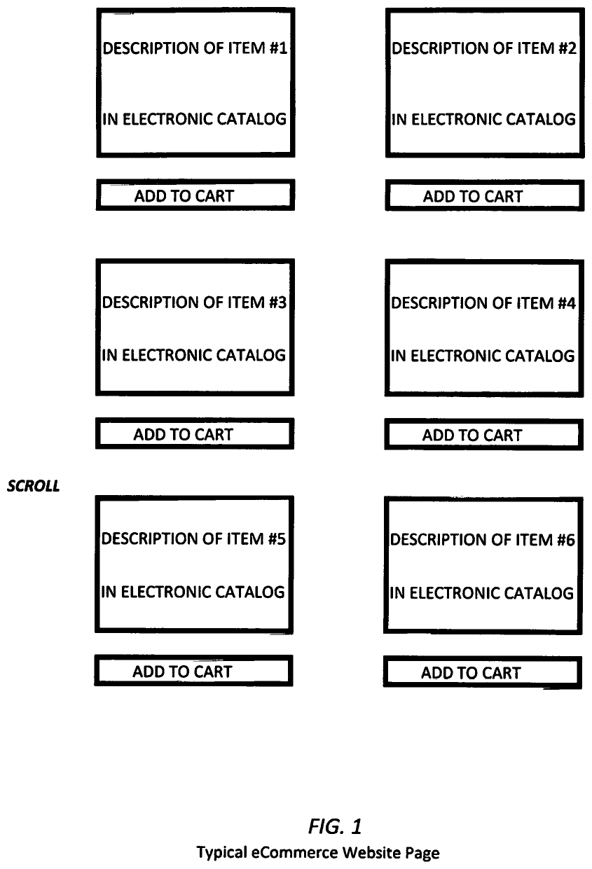

FIG. 1 illustrates a typical ecommerce website page used by an online store. In this illustrated case, the purchaser may select up to six items on this particular page. If the purchaser elects to buy an item they click on the item or item description and that item is placed in what is usually called the shopping cart page of the online store which is the second module or section of an online shopping cart model store. In this second section the purchaser can amend or cancel all or part of the order or elect to finalize the purchase in the third and final module or section which is usually called the check-out.

The present invention takes place solely within the eCatalog section described above.

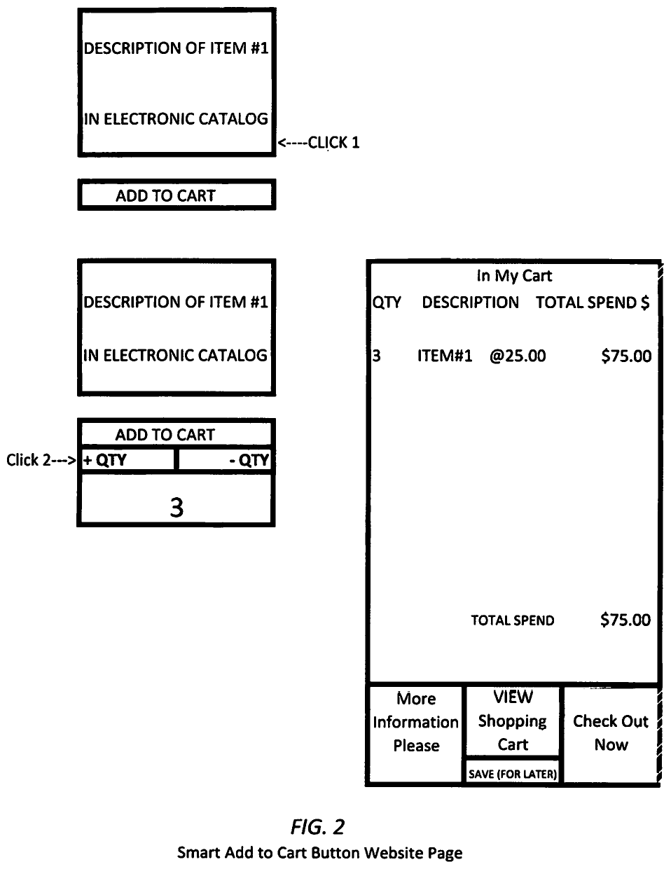

FIG. 2 illustrates how the present invention modifies all existing online shopping cart model stores. Now when the purchaser clicks on the item to be purchased (click 1 in FIG. 2) two pop-up windows appear. The first pop-up window changes the “Add-to-Cart” button to add a quantity indicator entitled “+QTY or −QTY” which allows the purchaser to readily change the quantity to be purchased by increasing the quantity by clicking the +QTY button or reducing the quantity by clicking the −QTY button. In this illustration the number “1” first appeared and this number was increased to “3” by the purchaser (Click 2 in FIG. 1). Simultaneously with the appearance of the “Add-to-Cart/Quantity” button, a second pop-up window is presented to the purchaser. This is a view only window that begins to summarize what the purchaser has elected to add to the shopping cart by showing what is “In-My-Cart”. In this illustration the view only pop-up window entitled “In-My-Cart” lists the quantity of the items purchased, a brief description of the item, the unit price of the item, the extended price of all items purchased and the total spend to date. A feature of these two pop-up menus is that they are dynamic in that they represent the real time status of each shopping event and the information contained in each window will remain in place until the purchaser cancels or consummates each purchase.

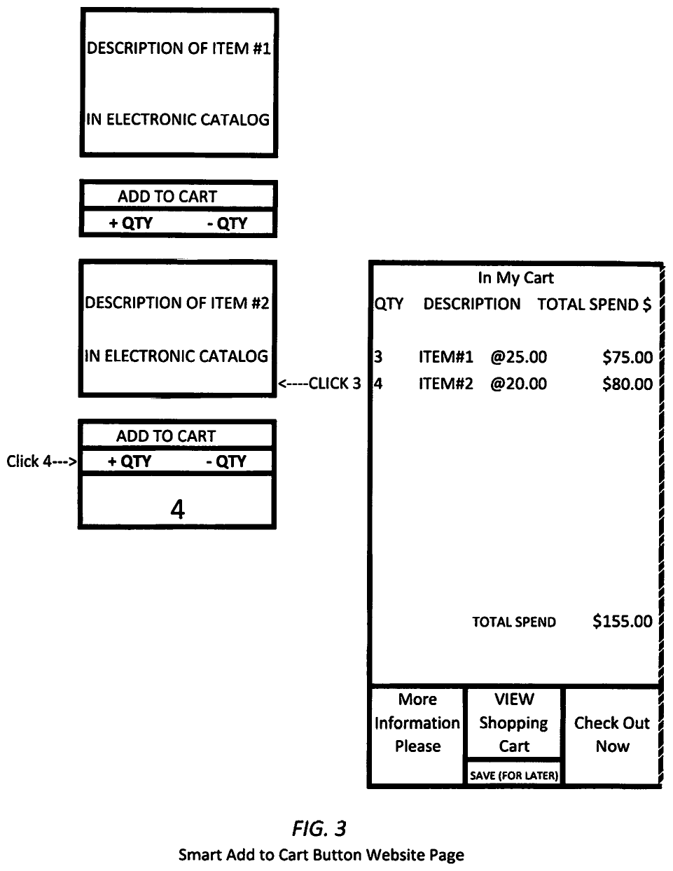

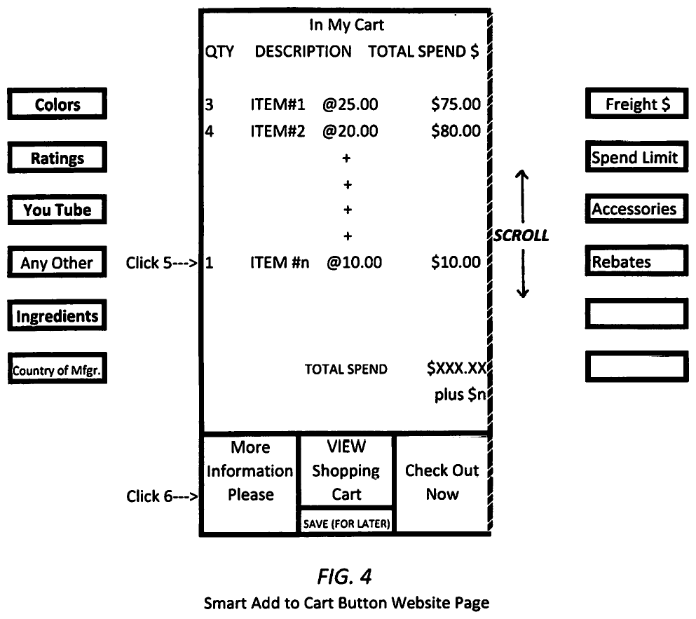

FIG. 3 illustrates how the addition of a second purchased item would appear in the “In-My-Cart” window. In this case the purchaser would have clicked on Item #2 (Click 3 in FIG. 3) and then on +QTY (Click 4 in FIG. 3) increasing the quantity purchased to 4 each of item #2. This method and system of keeping track of an order can go on indefinitely until the purchaser reaches all of the required items (Click 5 in FIG. 4).

FIG. 4 illustrates a truly unique feature of the present invention. There are many times when a purchaser has questions about a certain item that must be answered before a purchase can be made. The descriptions in the eCatalog might be incomplete or limited and more information is desired. The purchaser now has the option of clicking the “More information Please” section of the “In-My-Cart” window. This action will result in the appearance of additional pop-up windows. These additional pop-up windows can assist the purchaser by providing more information about an item. FIG. 4 illustrates just a few of these options such the color of an item, the rating of the item, a You Tube video of the product, the ingredients of an item, the country of manufacture of an item, the estimated freight cost of the shipping the items purchased to date, the spend limit, if any, for a particular shopping session or accessories that be considered with a particular item or any published rebate offer. All of this information can be prepared in advance in anticipation of a purchasers' questions or the information might be provided by hyperlinks to information contained on the internet. Additionally, tiered pop-up-windows might be provided to provide even more detailed information for each item to be purchased. These tiered windows are shown as the two empty windows in FIG. 4.

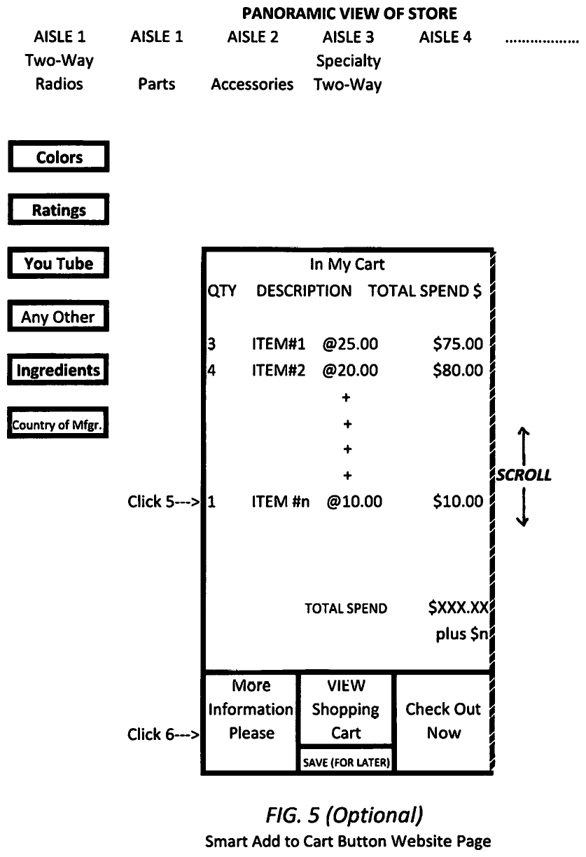

FIG. 5 illustrates an optional Panoramic View of the Store designed to simulate how a shopper might look around and get a sense as what is in a brick-and-mortar store.

At the completion of a particular shopping session the purchaser has several options as shown in the pop-up window in FIG. 4. The purchaser can go to the Shopping Cart module or section to view a more detailed view of all purchases or go directly to the checkout module or section. These two mentioned modules or sections are similar to those already available in the shopping cart model. The shopping might also be designated as “SAVE (FOR LATER)” and continued at a later time.

Although the present invention has been described in terms of possible embodiments, it is not intended that the invention be limited to these embodiments. Changes in design, wording placement, pop-up window and pull-down menu wording and placement within the spirit of the invention will be apparent to those skilled in the art. Also, various different single actions can be used to effect the selection and preparation of an order such as the click of a mouse in a computer system, a voice command, a key which may be depressed by a shopper, or a button on a television remote device which could be depressed by a shopper or any pointing device effected by a shopper.

1. A method and system for preparing a complete order to be placed on the internet, or other electronic shopping venue, consisting of one or more items which may be completed solely within the electronic catalog (e-catalog or eCatalog) section or module of an online shopping cart model comprising:
defining a shopping cart that “follows” an electronic shopper throughout an entire website shopping experience;
allowing the shopper to add or delete items to or from the shopping cart as is the case with existing shopping cart models but without having to leave the shopping cart to navigate to other pages on the website;
summarizing the results of the shopping cart contents as the shopping continues by showing a brief description of the items added to the shopping cart and calculating the dollar amount of the spend (or cost) on a real time basis as well as calculating additional costs or savings such as freight costs, tax costs, coupon savings, handling costs, and other factors which impact the final cost at checkout time;
providing windows of information which may be accessed from the shopping cart which are designed to give the shopper more information about prospective purchased item such as color options, ratings, ingredients, rebates, accessories, country of manufacture, videos and more information as may be required by the shopper.
